(19) United States
(12) Patent Application Publication
(10) Pub. No.: US 2015/0366643 A1
(43) Pub. Date: Dec. 24, 2015

(54) TOOTH VENEER ELEMENT, AND METHOD FOR THE USE AND PRODUCTION THEREOF

(71) Applicant: COLTÈNE/WHALEDENT AG, Altstaetten (CH)

(72) Inventors: Martin SchIüter, Wangen (DE); Mario José Besek, Thalwil (CH); Ralf Böhner, Kriessern (CH); Massimo De Martis, Balgach (CH); Remo Moser, Buchs (CH)

(21) Appl. No.: 14/764,774

(22) PCT Filed: Jan. 29, 2014
(86) PCT No.: PCT/EP14/51666

§ 371 Date: Jul. 30, 2015

(30) Foreign Application Priority Data
Jan. 31, 2013 (EP) 13153432.3

(51) Int. Cl. A61C 13/08

(52) U.S. Cl. CPC A61C 13/082

(57) ABSTRACT

The invention relates to a tooth veneer element (1), in particular for a human tooth (5), in particular for covering a facial cervical surface (6) of the tooth (5.1). The tooth veneer element (1) is designed to only partially cover a facial surface of a tooth crown (5.2) of the tooth (5.1). The invention also relates to a kit with a plurality of tooth veneer elements for veneering tooth surfaces, wherein the tooth veneer elements especially have different shapes and/or sizes and/or colours and/or degrees of translucency. The invention further relates to a method for applying such a tooth veneer element (1) to a tooth, wherein the tooth veneer element (1) is applied to the tooth in such a way that a facial surface of a tooth crown (5.2) of the tooth (5.1) is only partially covered, wherein in particular a facial cervical surface (6) of the tooth (5.1) is covered substantially completely.

The invention relates to a tooth veneer element, to methods for the application thereof, to the use of a tooth veneer element, and to a kit comprising tooth veneer elements, as per the preambles of the independent claims.

Tooth veneer shells, also referred to as veneers, are thin shells which are in the shape and color of teeth and which are applied to natural teeth. Such veneer shells are generally applied to the clearly visible front teeth for non-curative, aesthetic front tooth correction, and sometimes also for functional correction.

For this purpose, use may for example be made of fully ceramic veneer shells. These are manufactured individually in a laboratory in accordance with castings of a ground tooth or tooth stump, for example. The ceramic shells are in this case individually adapted to the natural teeth of the patient. The veneer shells thus manufactured are applied to the tooth or tooth stump by the dental surgeon. Such ceramic shells have the disadvantage that adaptation to the specific situation of the patient is not possible in situ. Furthermore, at least two visits to the dental surgeon are required (for creation of the casting and for the application process), and the manufacture of the individual ceramic shells is expensive.

A less expensive alternative is tooth veneers produced directly by the dental surgeon, so-called “chairside veneers”. These are constructed for example directly on the tooth or on the tooth stump, for example from known filler materials such as for example composite materials, by way of a layering technique. In this case, there are considerable demands with regard to the dental surgeon's sense of color and shape, because he or she, rather than the tooth technician in the laboratory, must create a natural and aesthetically pleasing shape.

What have proven to be particularly successful and inexpensive are prefabricated veneer shells composed of composite materials, so-called “direct veneers”, such as are also marketed by the applicant under the name Componeer®. Such veneer shells are normally provided in a selection of shapes and colors from which the dental surgeon can select on the basis of the individual requirements of the patient's tooth situation. The prefabricated veneer shells can be applied to the tooth or tooth stump using an adhesive, a so-called “bond” or “bonding”, such as for example a pasty composite material. In general, use is made in this case of light-polymerizable composite materials which are similar or identical to already known filler materials and/or to the material of the veneer shells. After application, the dental surgeon can, by contrast to the situation with ceramic shells, rework the composite shells by grinding and polishing in order to achieve an altogether individual and aesthetically high-quality result. To apply such veneer shells, it is generally necessary for the existing natural tooth to be ground down and/or etched at least on the facial surface. This is however associated with a not inconsiderable loss of tooth substance, which is often inappropriate in the light of the generally primarily aesthetic nature of the restoration.

It is therefore the object of the invention to overcome the disadvantages of the prior art. In particular, it is an object of the invention to provide an inexpensive tooth veneer element and a kit having a tooth veneer element, which tooth veneer element and kit can be used in a versatile manner, and the use of which is associated with the least possible loss of tooth substance, or even allows the tooth substance to be fully maintained. Furthermore, the tooth veneer element and the kit should be easy to produce and use. It is a further object of the invention to provide a method for applying a tooth veneer element and the use of a tooth veneer element, which method and use are implementable inexpensively and in a versatile and simple manner.

Said objects are achieved by means of the features of the independent claims. Claim 1 relates to a tooth veneer element for, in particular, a human tooth, in particular for covering a facial neck surface of the tooth. The tooth veneer element is characterized in that it is designed to only partially cover a facial surface of a tooth crown of the tooth.

The invention is based inter alia on the realization that a tooth veneer does not imperatively need to cover the entire facial surface of the tooth, in particular of the tooth crown, in order to achieve an aesthetically satisfactory result. Often, the defects to be concealed are situated only in a partial region of the facial surface of the tooth (hereinafter generally referred to as “local defects”). As has been found, local defects can be restored with high aesthetic quality simply by being covered with a tooth veneer element according to the invention. Modern materials for the manufacture of tooth veneer elements and adhesives (so-called “bonds” or “bondings”) permit adequate integration of the tooth veneer elements, such that, in the case of local defects, complete coverage of the facial surface is not necessary. In particular, the tooth veneer element according to the invention is particularly well-suited to use for local defects on a facial tooth neck surface, that is to say in a cervical region of the tooth at the transition from the tooth crown to the tooth root.

The tooth veneer element according to the invention is designed in the manner of a “partial veneer”, in particular in the cervical region, which partial veneer duly completely covers the facial region of the tooth in the desired region after being applied, but leaves other regions of the facial surface, in particular of the tooth crown, uncovered. When applied to provide coverage in the cervical region, the tooth veneer element is in particular designed and dimensioned such that, after correct application, it extends in the incisal or occlusal direction from the tooth neck over only part of the facial surface of the tooth crown. In other words, the tooth veneer element ends below a cutting edge or an edge of the masticatory surface of the tooth.

Owing to the only partial coverage, the tooth also only has to undergo preparation at most in said regions, or even does not need to undergo any preparation whatsoever. In this case, the other regions of the facial surface, or even the entire facial tooth surface, do not need to be ground down or subject to any other form of preparation. In this way, according to the invention, an unnecessary loss of valuable tooth material, in particular of the enamel of the tooth crown, can be reduced or even eliminated entirely.

The tooth veneer element may have different shapes (for example outline in the facial plan view or curvature in cross section) which are adapted specifically to the region of the local defects, adjacent surrounding regions, and to the tooth to which said tooth veneer is to be applied. In particular, for use for covering at least the cervical region, the tooth veneer element may for example be of collar-shaped form, such that it covers substantially only the tooth neck surface. Likewise, the tooth veneer element may extend somewhat further onto the tooth crown, giving rise to an altogether elongate shape. In general, the tooth veneer element narrows in a downward direction, as the tooth generally tapers in the tooth neck region in relation to the tooth crown. Depending on which tooth the tooth veneer element is provided for, the tooth veneer element may, at least in a lower section or in its entirety, have a curvature which is adapted to the facial root base of the tooth. Depending on the tooth to which the tooth veneer is to be applied, said curvature may differ considerably from a curvature of a section of the tooth veneer element that may extend onto the facial surface of the tooth crown.

The tooth veneer element according to the invention is preferably designed for application to the canines (cuspids), the premolars (bicuspids) or the molars (grinding teeth).

The tooth veneer element according to the invention thus differs considerably in terms of its shaping from known tooth veneer shells (that is to say complete veneers). The latter are designed to completely cover the facial surface of the tooth crown and thus correspond, for example in terms of outline, curvature and surface configuration, to an entire facial surface of an (if necessary idealized) natural tooth crown.

The tooth veneer element is preferably designed such that at least the facial tooth neck surface of the tooth can be substantially completely covered. Here, “substantially” completely refers to a generally not clearly specifiable boundary of the facial surface, on the one hand, and of the cervical region, on the other hand. In the present case, the facial tooth neck surface is regarded at least as being that zone at the transition from the enamel to the root element which is visible in a frontal plan view of the tooth.

Depending on the tooth or the extent of the local defects, it may be preferable for the tooth veneer element to be, for example, of more elongate form (longer than it is wide) or collar-shaped form (similar width to length, or wider than it is long).

In the present case, unless stated otherwise, “length” refers to a dimension of the tooth veneer element which, when the tooth veneer element is in an intended orientation relative to the tooth for application, is aligned parallel to the axial direction of the tooth. Correspondingly, “width” refers to a dimension perpendicular to the longitudinal direction.

In the case of an elongate form, an overlap with the tooth crown is generally larger, which, for example for improved integration into the patient's tooth situation, can provide greater design freedom for a transition from the tooth veneer element to the natural tooth surface. With a collar-shaped form, the tooth neck surface can if necessary be covered in more targeted fashion, such that the natural tooth crown is substantially exposed or is covered only in an edge zone in the direction of the tooth neck. It is self-evident that, under some circumstances, the tooth veneer element may even regionally extend as far as the tooth root.

The tooth veneer element advantageously has a length of approximately 5 to 12 mm, in particular of approximately 5.5 to 10.5 mm. It has been found that, with this dimensional range, adequate coverage in particular of exposed tooth neck surfaces can be ensured, with adequate overlap of the facial surface of the tooth crown, for most natural teeth.

The tooth veneer element preferably has a width of approximately 4 to 8 mm, in particular of approximately 5 to 7.5 mm. With this dimensional range, it is possible for adequate coverage, in particular of exposed facial tooth neck surfaces, to be ensured in the case of most natural teeth.

Tooth veneer elements which have a combination of a length of approximately 5 to 6 mm and a width of approximately 5 to 7 millimeters have proven to be particularly suitable. This dimension combination falls under the category, used in the present case, of a collar-shaped form. A length in the range from 9 to 10.5 mm in combination with a width of 6 to 7.5 mm has proven to be a further likewise particularly suitable combination. Said dimension combination falls under the category, used in the present case, of an elongate form.

The tooth veneer element advantageously has a thickness of approximately 0.2 to 1.0 mm, in particular of approximately 0.3 to 0.6 mm. In this way, it can be ensured that an often extremely large filling requirement can be provided in the tooth neck region, whereas a smooth transition to the natural surface of the tooth can be achieved at the tooth crown. Correspondingly, the tooth veneer element may be of relatively thick form in the section provided for the tooth neck region, and of relatively thin form in the section arranged on the tooth crown.

The tooth veneer element is preferably manufactured from a composite material. In this way, the tooth veneer element can be adapted and applied in a single visit to the dental surgeon. In this case, permanently good mechanical characteristics and an aesthetic restoration are ensured.

Suitable composite materials comprise an organic plastics matrix (organic phase) which is supplemented with an inorganic, in particular solid, filler (inorganic phase). It is advantageous for the organic plastics matrix to comprise at least a methyl acrylate and/or for the inorganic filler to comprise at least a glass. As glass, use is preferably made of a barium glass and/or a strontium glass.

Further preferred inorganic filler materials are amorphous, for example spherical materials based for example on mixed oxides of SiO₂, ZrO₂ and/or TiO₂, microfine fillers such as pyrogenic silicic acid or precipitated silicic acid and macro-(particle size from approximately 5 μm to approximately 200 μm) or micro-fillers (particle size from approximately 0.5 to approximately 5 μm) such as quartz (silicate, sands), glass ceramics (for example barium-aluminum glass) or glass powder with an average particle size from 0.5 μm to 5 μm and x-ray-opaque fillers such as ytterbium fluoride. Likewise, the filler may also comprise so-called micro-filler complexes such as for example hybrid composites and nanoparticles (nano-hybrid composites). Furthermore, glass fibers, polyamides or carbon fibers may basically also be used as fillers. The surface of the filler is generally silanized in order to permit bonding to the organic matrix.

Further suitable polymerizable monofunctional or multifunctional monomers of the organic phase are mono (meth)acrylates, such as methyl, ethyl, butyl, benzyl, furfuryl or phenyl (meth) acrylate, multifunctional acrylates and methacrylates such as for example bisphenol (A) di(meth)acrylate, bisphenol A glycidyl methacrylate (known as “bis GMA”, which is an addition product of methacrylic acid and bisphenol A diglycidyl ether), UDMA (an addition product of 2-hydroxyethyl methacrylate and 2,2,4-hexamethylene diisocyanate), di-, tri- and tetraethylene glycol di(meth)acrylate (such as for example TEGDMA), decandiol di(meth)acrylate, trimethylolpropane tri(meth)acrylate, pentaerythritol tetra(meth)acrylate, 1,10-decandiol di(meth)acrylate or 1,12-dodecandiol di(meth)acrylate. Organic phases comprising methacrylate modified polysiloxanes are likewise known.

The curing of the composite material occurs owing to suitable initiators and, if appropriate, further polymerization-capable components, for example by thermal (thermal curing), photochemical (light curing) or redox-induced polymerization (chemical hardening). In this case, in the presence of different polymerization-capable groups, for example of methacrylate and epoxy groups, it is also possible for multiple curing mechanisms, for example free-radical and cationic polymerization, to be used simultaneously or in successive stages.

Preferred initiators for the thermal curing are peroxides such as, for example, dibenzoyl peroxide, dilauroyl peroxide, tert-butyl peroctoate and tert-butyl perbenzoate and azobisisobutyrate ethyl ester, benzopinacol and 2,2-dimethyl benzopinacol.

Preferred photoinitiators are benzophenone and benzoine and their derivatives, α-diketones and their derivatives, such as for example 9,10-phenanthrenequinone, diacetyl and 4,4-dichlorobenzyl. Further preferred photoinitiators are 2,2-methoxy-2-phenyl acetophenone and in particular combinations of α-diketones with amines as reductant, such as for example N-cyanoethyl-N-methylaniline, 4-(N,N-benzoic acid ester, N,N-dimethylamino ethyl methacrylate, N,N-dimethyl-sym-xylidine or triethanolamine. Furthermore, acyl phosphines, such as for example 2,4,6 trimethyl benzoyl diphenyl or bis-(2,6-dichlorobenzoyl)-4-N-propylphenylphosphine oxide, are suitable as photoinitiators. Particularly preferred photoinitiators are camphorquinone, which absorbs light with a wavelength of 440 to 480 nm and can thereby be activated, or phenyl propanediol, which can be activated by light with a wavelength of 300 to 450 nm.

For dual curing of systems capable of free-radical and cationic polymerization, diaryliodonium or triarylsulfonium salts, such as for example triphenylsulfonium hexafluorophosphate and hexafluoroantimonate, are particularly suitable.

As initiators for a redox-induced polymerization (chemical curing) at room temperature or low temperatures, use is made of redox initiator combinations such as, for example, combinations of benzoyl or lauroyl peroxide with N,N-dimethyl-sym-xylidine or N,N-dimethyl-p-toluidinie. In general, use is made here of 2-component systems in the case of which mixing of the two components causes the initiator to be activated and the polymerization to be triggered.

The composite material may in this case have further constituents such as, for example, mono-, di- and triacrylates as comonomers or for example toluidine as an accelerant of the photopolymerization. Further additives may for example be polymerization inhibitors for preventing premature polymerization, such as for example hydroquinone as an inhibitor of photopolymerization. Furthermore, provision may also be made of further additives such as benzophenone as UV stabilizer, oxidation inhibitors, leveling agents, colorants (pigments and dyes), stabilizers, flavorings, microbiocidal agents and/or plasticizers.

The tooth veneer element advantageously comprises zinc oxide. Zinc oxide is known as a biomaterial and is used in biological systems inter alia owing to its microbiocidal action. Specifically in the case of the tooth veneer element being applied in the region of the tooth neck, that is to say to possibly inflamed gums, it is therefore advantageous for the material of the tooth veneer element to be correspondingly enriched and/or coated.

The tooth veneer element may advantageously be provided with a surface coating. The surface coating is provided in particular after a shape-imparting production step, and may also extend only over certain regions of the tooth veneer element. In this case, the surface treatment may be a surface finishing which is applied or carried out in particular in the regions which are visible after application. In this way, it is ensured that even regions which, if necessary, remain unmachined upon the application of the tooth veneer elements have a high surface quality.

The surface finishing may for example be surface polishing. For the surface finishing, it is however also possible for an outer surface of the tooth veneer element to be subjected to laser treatment at least in regions.

In other surface regions which are provided for example for fastening to the tooth, that is to say for contact with the adhesive, surface treatment may be provided for the purposes of improving the adhesion of the adhesive. In this case, the surface treatment may for example encompass roughening of the fastening surfaces.

The tooth veneer element may have a translucency in the range from approximately 12% to 45%, preferably in the range from approximately 12% to 30%. It has been found that the tooth veneer element according to the invention can, depending on usage, have a lower translucency than conventional veneers. In particular for the veneering of tooth neck surfaces, the tooth veneer elements may preferably have a color tone of dentine color and a lower translucency. In this case, for example, a multiplicity of tooth veneer elements are provided which have a selection of different color tones that can be used in as versatile a manner as possible.

It is self-evident that, depending on usage, the tooth veneer elements according to the invention may also be of translucent form, for example if they are provided for partially veneering the facial surface of the tooth crown, for example in the region of the cutting edge. In this way, similarly to known complete veneers, it is possible for the color of an adhesive situated underneath to show through, such that, with suitable color selection of adhesive and tooth veneer element, the visual effect of a natural tooth with differently colored dentine and enamel can be recreated.

The tooth veneer element in any case preferably has adequate permeability to light, which is used if appropriate for the curing of the adhesive. In general, a translucency of approximately 12% is adequate for this purpose. Typically, for curing with light, use is made of blue light in the wavelength range from 300 nm to 500 nm.

Suitable color values and/or translucencies are, in order to cover as broad as possible a range of requirements, determined empirically by comparisons with different natural teeth. For the definition of a color value, use may basically be made of different color models. What is widely used and well proven is a description of the collar in the so-called Lab color space, which covers the range of visible colors. The Lab color model is independent of equipment, that is to say the colors are defined independently of the technology used for generating and rendering them. The color model is standardized in EN ISO 11664-4:2008. In this color model, the tooth veneer element according to the invention has color values which preferably lie in the following ranges:
L value in the range from 55 to 88;
a value in the range from −4 to 4.5;
b value in the range from −2 to 24.

It has been found that, with these color values, in particular in conjunction with a translucency in the range from 12% to 45%, preferably in the range from 12% to 30%, the tooth veneer elements according to the invention, in particular for covering a tooth neck surface, can be used in a particularly versatile manner and lead to results with a natural appearance.

Other color values are self-evidently also conceivable depending on the requirements and usage of the tooth veneer elements according to the invention. For example, in the case of complete tooth veneers, L values from 60 to 66.7, a values from −3.0 to −0.3 and b values from −1.0 to 3.6, in particular in the case of a translucency from 33% to 41%, have proven to be expedient. In the case of tooth veneer elements according to the invention which are not provided for veneering only tooth neck surfaces, values similar to those of complete tooth veneers may be preferable depending on requirements.

The tooth veneer elements are preferably equipped with a placement aid by way of which the tooth veneer element can be directly or indirectly held by a user. In this case, the placement aid serves as a provided gripping point at which the tooth veneer element can be held for example by way of forceps. In this way, it is possible for the relatively small tooth veneer element to be handled comfortably and easily. The placement aid can be removed after the application process, for example by being ground off, cut off or broken off at a predetermined breaking point.

It is self-evident that a placement aid of said type may also be advantageous as an independent aspect, for example in the case of tooth veneer elements for completely covering a facial surface of the tooth, in particular the tooth crown. In other words, a further aspect of the invention also relates generally to a tooth veneer element, in particular a veneer, which is provided with a placement aid by which the tooth veneer element can be held by a user. It is self-evident that a tooth veneer element of said type may also have the preferred features mentioned here, individually or in combination.

The placement aid is advantageously formed in particular integrally on the tooth veneer element, or fastened to the tooth veneer element in particular by adhesive bonding. In the case of a deformation-type production process for the tooth veneer element, the placement aid may accordingly be formed as an integral constituent part of the tooth veneer element. Alternatively, the placement aid may be produced in a separate manufacturing process and applied subsequently to the fully shaped tooth veneer element.

The placement aid is preferably arranged on an outer surface of the tooth veneer element. In this case, the outer surface refers to a surface which, after process of application to the tooth, is arranged facially. In this way, the tooth veneer element can be held by way of the placement aid for convenient alignment even during the process of application to a tooth. The placement aid preferably protrudes substantially perpendicularly from the facial surface of the tooth veneer element.

In this case, the placement aid is preferably in the form of a projection. The projection is preferably designed such that the tooth veneer element can be held by way of the projection directly or indirectly, for example using forceps. The placement aid is preferably designed such that the tooth veneer element can be held by way of the placement aid equally effectively regardless of the orientation of the tooth veneer element. For this purpose, the placement aid may be of peg-shaped form, in particular in the form of a substantially circular-cylindrical stub. It is self-evident that other cross sections of the peg-shaped placement aid, such as for example polygonal or oval cross sections, may also be advantageous if appropriate.

The placement aid is provided for removal from the tooth veneer element before the final machining of the restoration process. For this purpose, a predetermined breaking point is advantageously provided for the separation of the placement aid from the tooth veneer element. In this way, the placement aid can be easily separated off, for example broken off, at the predetermined breaking point after the tooth veneer element has been applied. A projection that may remain on the tooth veneer element can be ground off, and if necessary polished, during the finish machining process. It is self-evident that, in variants, there is no need for a predetermined breaking point to be provided, and the placement aid is designed such that it can be separated off using a tool such as for example a cutting disk.

It has proven to be advantageous for the predetermined breaking point to comprise a step, which in particular fully encircles the placement aid, between the tooth veneer element and the placement aid. In particular, there may be formed on the tooth veneer element a pedestal which merges via the step into the placement aid. It can be ensured in this way that the fracture point that remains after the placement aid has been separated off, which fracture point in this case is formed on the pedestal, does not extend into the body of the tooth veneer element and only needs to be ground down (that is to say there is no need for reconstructive post-processing). In other embodiments, the predetermined breaking point may for example also be in the form of a notch which is formed so as to encircle the placement aid or is formed on one side.

Here, it may be advantageous for the placement aid to have a coding, for example a barcode and/or a color coding, for identification of the tooth veneer element. This permits easy visual distinction between different types of tooth veneer elements. Since the placement aid is removed after the application of the tooth veneer element in any case, an aesthetic effect of the final veneering is not impaired by the coding. The coding may for example comprise a barcode, and/or preferably a color coding, which is particularly easy for a user to understand. It is basically also possible for the coding to be formed in some other region of the tooth veneer element, wherein said coding should however be no longer visible after the tooth veneer element has been applied.

The invention also provides a kit having multiple tooth veneer elements for veneering tooth surfaces, wherein in particular, the tooth veneer elements have different shapes and/or sizes and/or colors and/or translucencies, wherein at least one of the tooth veneer elements is designed as a tooth veneer element according to one of the aspects of the invention. The at least one tooth veneer element is preferably provided for application to canines, premolars or molars.

The kit preferably comprises a selection of shapes and sizes which ensure the broadest possible range of applicability. It has been found that two different sizes and two different shapes, that is to say a total of four variants, for each tooth may suffice in most cases. The kit thus preferably comprises at least four variants of a tooth veneer element according to the invention, in particular to different shapes, and each of said shapes in two different sizes, for each tooth.

A kit of said type may furthermore comprise fluid and/or viscous and/or pasty adhesives, and/or fillers of corresponding condition. Said materials may already be provided in different color tones. Alternatively or in addition, colorants may be provided which permit retroactive coloring. The kit may furthermore comprise further substances such as for example adhesion promoters. It is self-evident that a kit of said type may also include instruments and tools such as forceps and/or grinding devices and/or special application instruments for the application of the tooth veneer elements. It is likewise possible for a color key for determining suitable color tones of tooth veneer elements and/or adhesives or fillers, and templates for determining suitable sizes and/or shapes of the tooth veneer elements. If appropriate, the color keys and the templates may be provided with codings, in particular color codings, which correspond to the codings provided on the tooth veneer elements. In this way, suitable tooth veneer elements can be determined particularly easily by a user.

The kit may furthermore comprise instructions for a user for applying the tooth veneer elements. The instructions may for example include specifications regarding the preparation of the natural tooth before the tooth veneer element can be applied, if such preparation is necessary at all in individual cases. In particular, the instructions may also comprise specifications regarding the carrying out of a method according to the invention, as described here.

The invention also relates to the use of a tooth veneer element, in particular of a tooth veneer element as described here, for partially covering a facial surface of a tooth crown of a in particular human tooth, wherein in particular, a facial tooth neck surface of the tooth is substantially completely covered. The tooth veneer element is preferably used for non-curative, aesthetic tooth correction. Further features relating to the use of the tooth veneer element will emerge from the following description in conjunction with the further aspects of the invention.

The invention also relates to a method for applying a tooth veneer element, in particular a tooth veneer element according to one of the aspects of the invention, to a tooth. The method is characterized in that the tooth veneer element is applied to the tooth such that a facial surface of the tooth crown of the tooth is only partially covered, wherein in particular, a facial tooth neck surface of the tooth is substantially completely covered. The application method and the use of the tooth veneer element are preferably implemented for non-curative aesthetic tooth correction, that is to say for cosmetic purposes. It is self-evident that, in the case of curative tooth correction, for example the treatment of sensitive tooth necks, it is basically possible for the same method and the same use as described here to be implemented. In the case of non-curative, aesthetic tooth correction, there is often no need whatsoever for prior preparation of the tooth.

In a preferred variant of the method, the tooth veneer element, after being applied to the tooth, is subjected to material removal, in particular grinding, such that a substantially smooth transition from the tooth veneer element to the facial surface of the tooth crown is realized. In this case, material removal is performed in particular on an upper edge, at the tooth crown side, of the tooth veneer element.

The method is preferably used with a tooth veneer element having a placement aid, as described above. In this case, during the application process, the tooth veneer element is at least temporarily held by a user directly or indirectly by way of the placement aid of the tooth veneer element. In this way, the tooth veneer element can be manipulated and positioned easily.

The tooth veneer element may for example be held by way of the placement aid using forceps. It is likewise possible for an application instrument provided specifically for the purpose to be used. An application instrument of said type may for example be adapted to the placement aid and may for example be designed complementarily thereto. In particular, the application instrument may have a preferably elastic holding element, composed in particular of silicon or rubber, with a receiving space into which the correspondingly designed placement aid can be inserted. With suitable dimensions of the receiving space, the placement aid of the tooth veneer element can thus be inserted into and held in the receiving space. An advantageous refinement comprises a peg-shaped form of the placement aid, wherein the receiving space is in the form of a blind bore in the holding element. The application element preferably has a handle for ease of handling, to which handle the holding element is connected.

It is advantageously the case that, after the tooth veneer element has been applied, the placement aid is separated from the tooth veneer element, in particular at a predetermined breaking point for the separation of the placement aid from the tooth veneer element. In the case of a predetermined breaking point, the placement aid can be broken off easily. Otherwise, it may for example be separated off mechanically by way of a cutting disk.

If the placement aid has a coding, it is preferably the case that, before the tooth veneer element is applied to the tooth, a suitable tooth veneer element is selected from a multiplicity of, in particular different, tooth veneer elements on the basis of the coding, in particular a barcode and/or a color coding.

The invention also relates to a method for producing a tooth veneer element, in particular a tooth veneer element according to the invention. In this case, a fluid, viscous or pasty composite material is:
introduced into a pressing mold,
pressed into a desired shape by the pressing mold, and
subsequently cured.

The polymerization required for the curing of the composite material can be initiated by activation of suitable initiators and the composite material, as described above in conjunction with the composite material.

If necessary, a placement aid may be attached to the tooth veneer element after the curing process. The placement aid is however preferably integrally formed directly during the production of the tooth veneer element. The placement aid may be equipped with a coding, in particular a color coding, or equipped therewith after the curing or if appropriate the application process.

In the case of the placement aid being formed integrally, the aforementioned predetermined breaking point for the separation of the placement aid from the tooth veneer element can be formed simultaneously. The pressing mold may be correspondingly designed for this purpose.

It is preferably the case that a ventilation duct, which is provided in any case, of the pressing mold, via which ventilation duct excess air can escape from the pressing mold during the pressing process, serves as a mold for forming the placement aid. The ventilation duct is preferably arranged and designed such that composite material that enters the ventilation duct during the pressing process can, after the curing process, form the placement aid. If appropriate, an amount of composite material slightly greater than that required for the manufacture of the tooth veneer element on its own, that is to say without the placement aid, is introduced into the pressing mold.

For this purpose, the ventilation duct preferably opens out into a pressing chamber of the pressing mold at a pressing mold press surface which shapes an outer side, provided as facial surface, of the subsequent tooth veneer element. The invention thus also relates, in a further aspect, to a pressing mold for producing a tooth veneer element, in the case of which pressing mold a ventilation duct opens out into a pressing chamber of the pressing mold at a pressing mold press surface, which press surface is provided for shaping an outer side, provided as facial surface, of the subsequent tooth veneer element. The ventilation duct preferably has a shape complementary to the subsequent placement aid, or in other words forms a negative mold for the placement aid. In particular, the ventilation duct may have a step which, on the placement aid, yields a predetermined breaking point in the form of a step. The ventilation duct preferably has a cross section larger than that required for ventilation alone.

Further advantageous embodiments and feature combinations of the invention will also emerge from the following detailed description and the patent claims in their entirety.

In the drawings used for the explanation of the exemplary embodiments, in each case schematically:

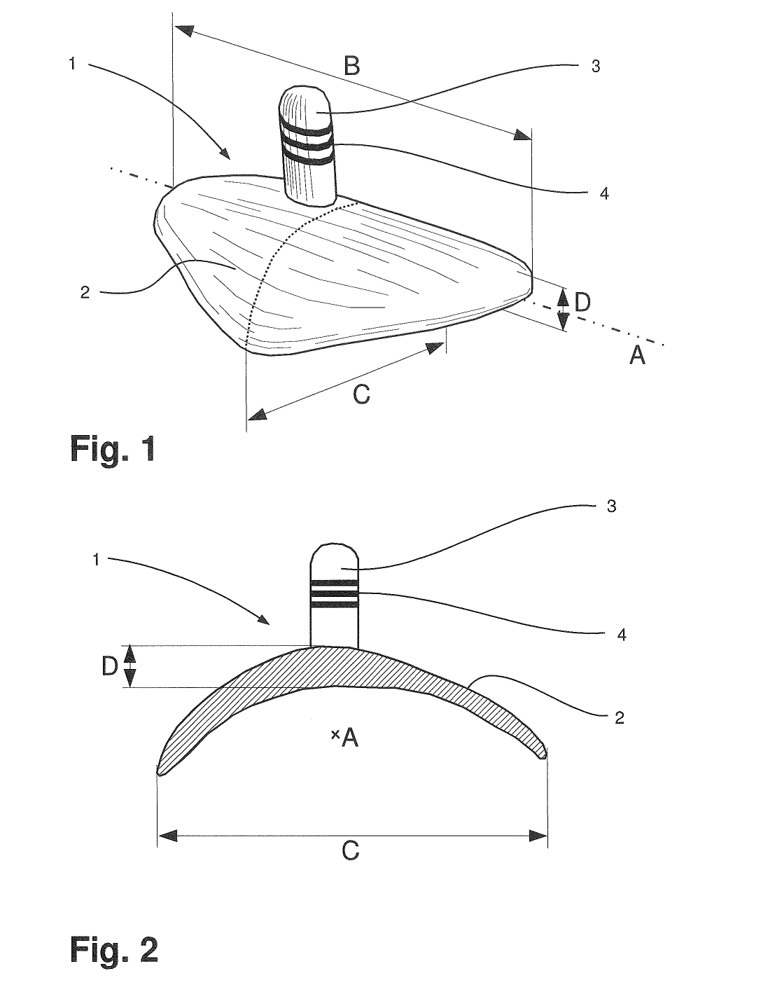

FIG. 1 shows an external view of a tooth veneer element according to the invention for the veneering of a cervical region of a tooth, the tooth veneer element having a placement aid;

FIG. 2 shows an exemplary cross-sectional view through the tooth veneer element of FIG. 1;

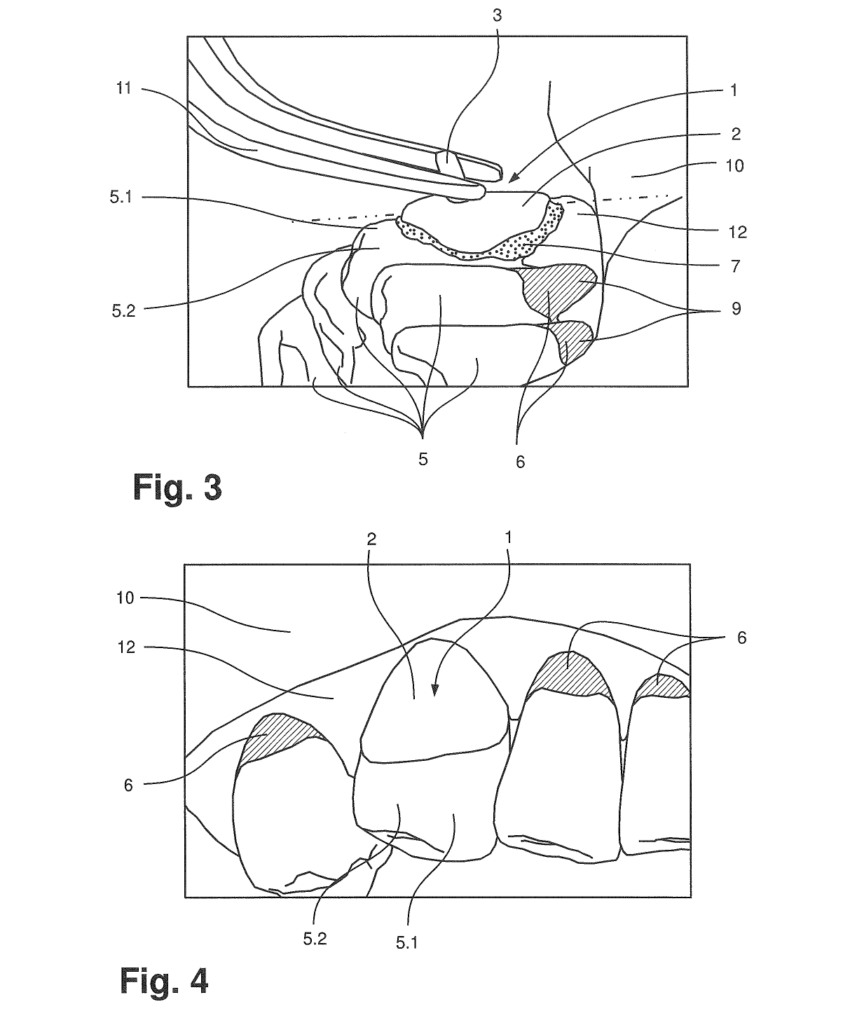

FIG. 3 shows a view of a tooth situation of a patient during the application of the tooth veneer element as per FIG. 1;

FIG. 4 shows a view of a tooth situation of a patient after the application of the tooth veneer element, with the placement aid having been removed, before the finish machining process;

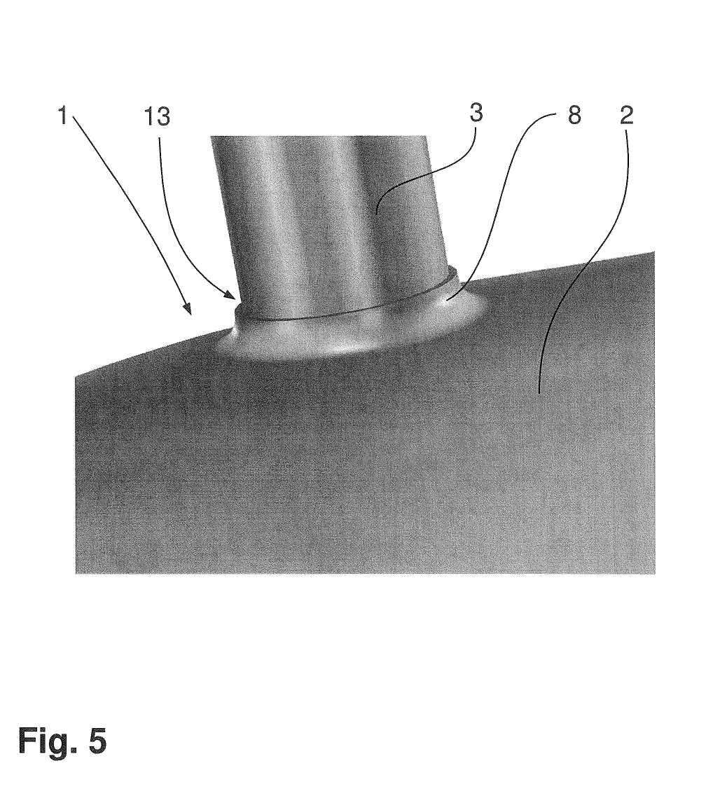

FIG. 5 shows a detail view of a tooth veneer element according to the invention having a placement aid with a predetermined breaking point;

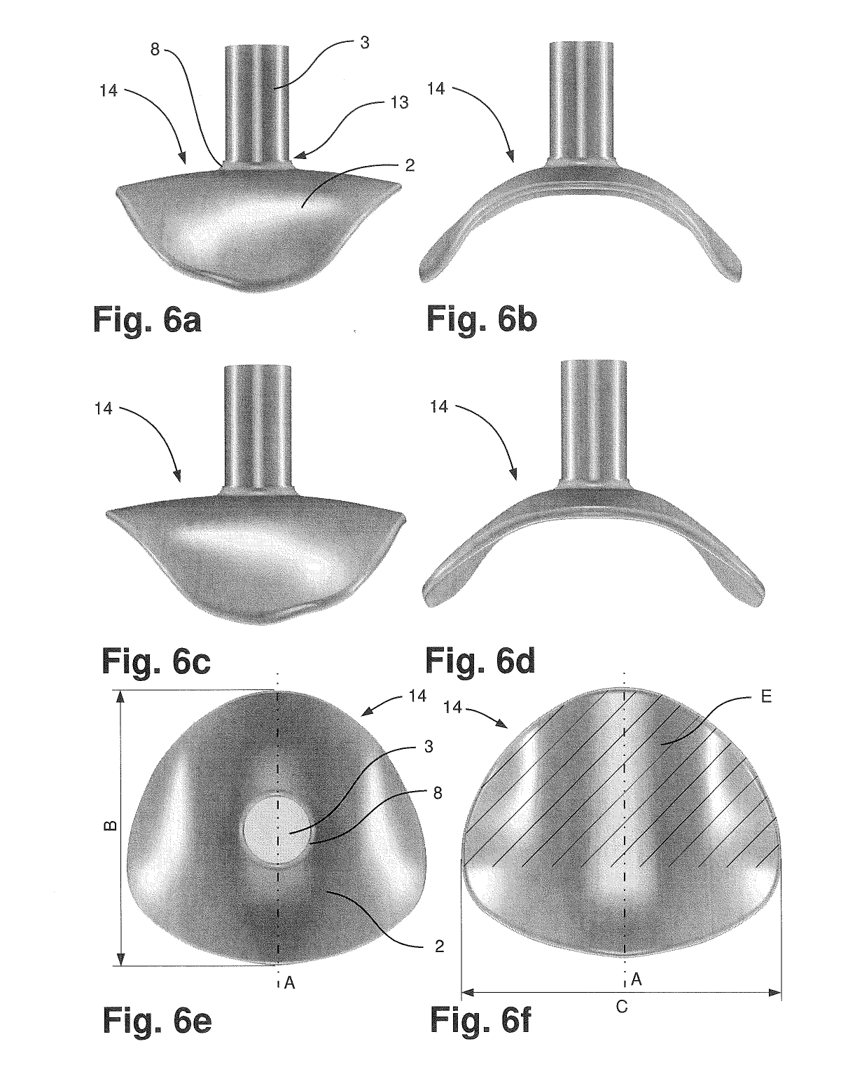

FIGS. 6a-6f: show six main views of a further embodiment of a tooth veneer element according to the invention for the veneering of a cervical region of a tooth, the tooth veneer element having a placement aid with a predetermined breaking point;

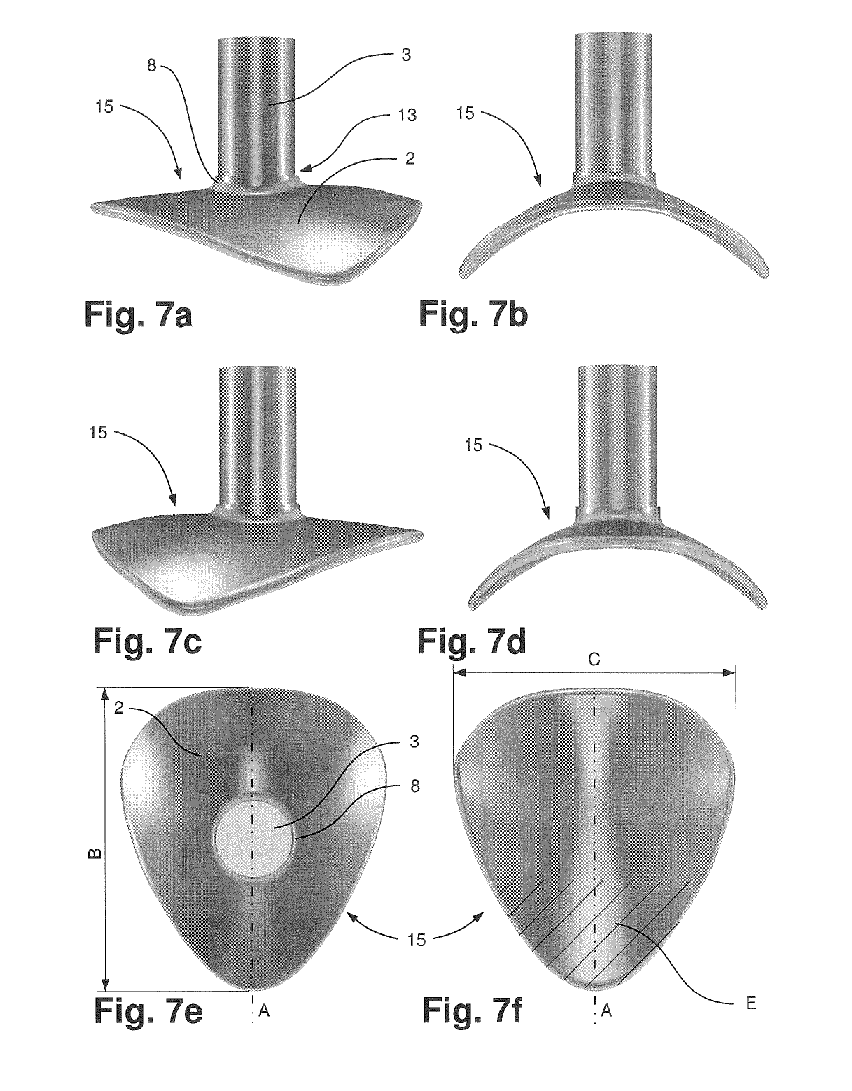

FIGS. 7a-7f: show six main views of a further embodiment of a tooth veneer element according to the invention for the veneering of a cervical region of a tooth, the tooth veneer element having a placement aid with a predetermined breaking point;

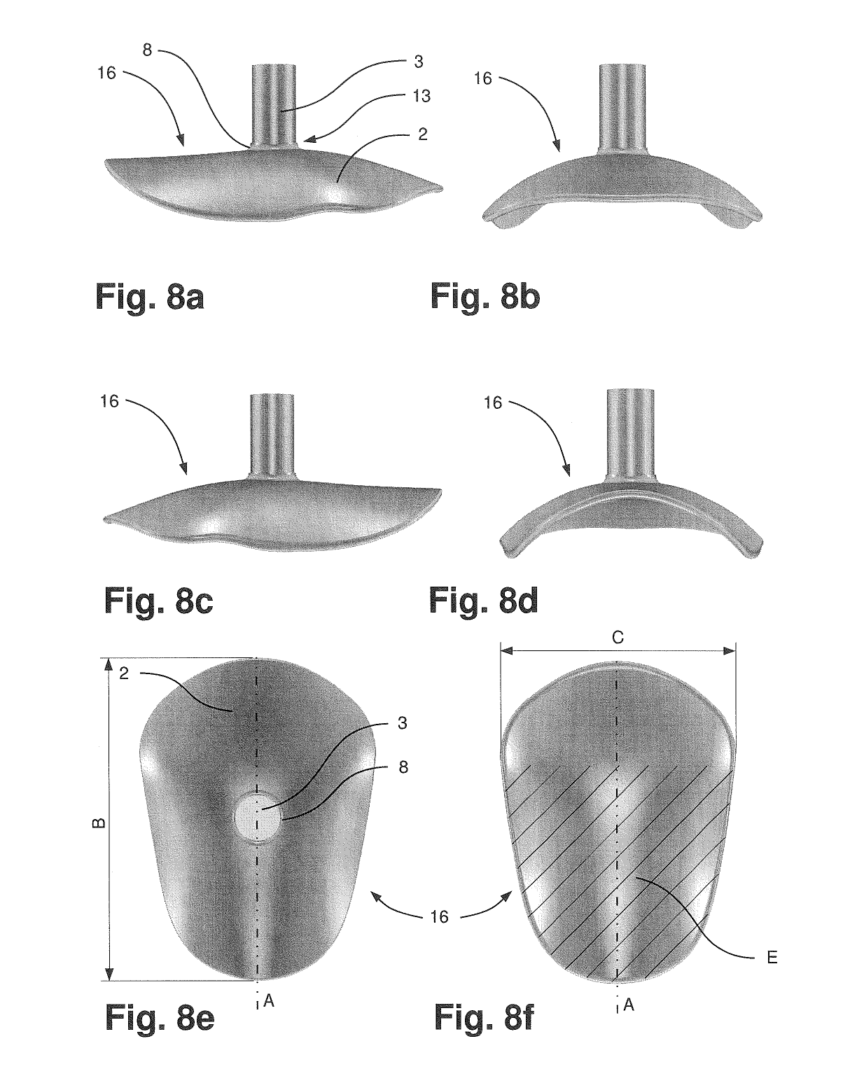

FIGS. 8a-8f: show six main views of a further embodiment of a tooth veneer element according to the invention for the veneering of a cervical region of a tooth, the tooth veneer element having a placement aid with a predetermined breaking point;

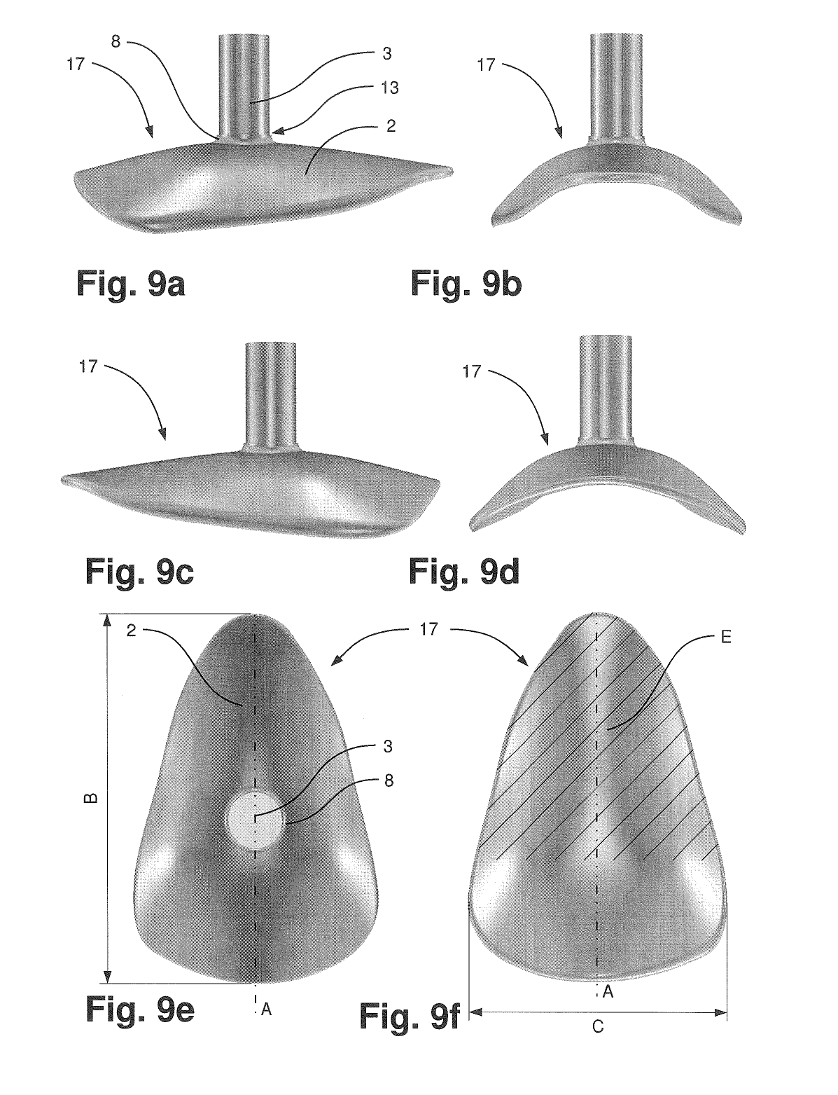

FIGS. 9a-9f: show six main views of a further embodiment of a tooth veneer element according to the invention for the veneering of a cervical region of a tooth, the tooth veneer element having a placement aid with a predetermined breaking point.

In the figures, similar elements are denoted by the same reference signs.

FIG. 1 shows a schematic internal view of a tooth veneer element 1 according to the invention. FIG. 1 depicts an oblique view. To illustrate a curvature of the tooth veneer element 1, surface lines are shown, which are however not intended to depict a specific surface structuring. The tooth veneer element 1 is curved about a longitudinal axis A (in this regard, see also FIG. 2, and FIGS. 6a to 6f, 7a to 7f, 8a to 8f and 9a to 9f). The longitudinal axis A is, in a projection onto the facial surface of the tooth 5.1, oriented along a longitudinal axis of the tooth 5.1 when the tooth veneer element 1 is arranged in an intended alignment for application (see for example FIG. 3).

The tooth veneer element 1 has a length B in the direction of the longitudinal axis A in the range from approximately 5 to 12 mm. Perpendicular to the longitudinal direction A, the tooth veneer element 1 has a width C in the range from approximately 4 to 8 mm. A thickness D of the tooth veneer element 1 is approximately 0.2 to 1.0 mm, in particular 0.3 to 0.6 mm. It is self-evident that the thickness D may in this case vary depending on the measurement position on the tooth veneer element 1. In particular, it is for example possible for a thickness to be smaller in a region at the tooth crown side than in a region at the root side, where a greater amount of material removal may be desirable.

On an outer surface 2 of the tooth veneer element 1, which is machined after the process of application to a facial surface of the restored tooth, there is arranged a placement aid 3. The latter is arranged in a central region of the surface 2 and is fastened thereto or integrally formed thereon. The placement aid 3 is in the present case in the form of a substantially cylindrical stub which is arranged substantially perpendicular to the surface 2. The placement aid 3 is provided for use only during the application and/or during the preparation of the tooth veneer element 1. After the application process, the placement aid 3 can be removed, for example by being broken off at a predetermined breaking point (in this regard, see FIG. 5) or by being separated off by way of a grinding or cutting tool.

In the present case, a coding 4 in the form of multiple encircling rings is applied to the placement aid 3. Here, the rings may be of different colors in order to indicate for example a size or a color of the tooth veneer element 1. This makes it easier for the user to identify different tooth veneer elements 1. It is self-evident that the coding 4 may also take some other form, and may for example comprise rings which are of the same color but of different widths, or a label with a numerical code. Owing to the fact that the placement aid 3 has to be removed in any case before the finish machining process of the restoration, the coding 4 does not impair the aesthetic quality of the tooth veneer element 1 in terms of the end result.

FIG. 2 schematically shows an exemplary sectional view through the tooth veneer element 1 of FIG. 1. The sectional view lies in a plane perpendicular to the longitudinal direction A (dashed line in FIG. 1). It is self-evident that the design of the tooth veneer element 1, such as for example a curvature, thickness or surface structuring, may vary depending on which teeth, or which regions of the teeth, said tooth veneer element is provided for.

FIG. 3 schematically shows a view of a tooth situation of a patient during the application of the tooth veneer element 1 by a user, such as for example a dental surgeon. FIG. 3 shows multiple still-untreated teeth 5 of the patient. At the tooth necks 9 of the teeth 5, it is possible, in a cervical region, to see exposed facial tooth neck surfaces 6, such as may arise for example owing to receding gums 12. In the illustration of FIG. 3, the rest of the mouth cavity is covered for shielding purposes, for example by way of a dental dam 10.

A tooth veneer element 1, held by way of the placement aid 3 using forceps 11, is placed, using an adhesive 7, on a tooth 5.1 of the teeth 5, such that an exposed tooth neck surface of the tooth 5.1 is completely covered. FIG. 3 shows a situation during the positioning of the tooth veneer element 1. As can be seen, the tooth veneer element 1 duly partially covers a facial surface of the tooth crown 5.2 of the tooth 5.1. The tooth veneer element 1 however extends only over up to approximately ⅔ of the axial length of the tooth crown 5.2 in the direction of a cutting edge of the tooth 5.1. The remaining region of the facial surface of the tooth crown 5.2 as far as the cutting edge remains uncovered. The exposed region of the tooth crown 5.2 therefore also does not need to undergo preparation. In particular, there is no need for tooth enamel to be removed.

Between the tooth veneer element 1 and the tooth 5.1 there is arranged an adhesive 7 (dotted). In the present case, some of said adhesive has spread out from between the tooth veneer element 1 and the tooth 5.1. The excess adhesive 7 is removed before the adhesive 7 cures.

FIG. 4 shows a tooth situation of the patient after the tooth veneer element has been correctly positioned on the tooth 5.1. The excess adhesive 7 has been removed, and the remaining adhesive 7 between tooth veneer element 1 and tooth 5.1 has cured. As mentioned, in the case of common adhesives 7, which are for example in the form of known fillers composed of composite material, said curing is typically effected by irradiation with light in the range from 300-500 nm (light polymerization). For this purpose, the tooth veneer element 1 is permeable to the required light to the greatest possible extent, in order that adequate irradiation into the adhesive 7 is possible.

FIG. 4 shows the tooth situation before the conclusion of the restoration by finish machining. A transition from the tooth veneer element 1 to the surface of the tooth crown 5.2 has not yet been ground down, and the facial surface of the restored tooth 5.1 has not yet been polished. However, the placement aid 3 has already been removed from the tooth veneer element 1. The further teeth 5 are illustrated without restoration, that is to say tooth veneers. It is possible to clearly see the tooth neck surfaces 6 exposed by the gum 12, which tooth neck surfaces can, during the further treatment using tooth veneer elements 1, be covered analogously to the tooth 5.1.

FIG. 5 shows a detail view of the tooth veneer element 1 with the placement aid 3. On the facial surface 2 of the tooth veneer element 1 there is formed a circular pedestal 8 which is raised in relation to the facial surface 2. The pedestal 8 has, in the direction of the tooth veneer element 1, flanks which diverge from one another in concave fashion.

From the pedestal 8, the placement aid, which is in the form of a cylindrical stub, extends away from the tooth veneer element 1 substantially perpendicularly to the surface 2. At the transition from the pedestal 8 to the placement aid 3 there is formed a step 13, at which there is an abrupt narrowing from the cross section of the pedestal 8 to the cross section of the placement aid 3. The step extends around the entire placement aid 3 with respect to a longitudinal axis of the placement aid 3.

The step 13 forms a predetermined breaking point at which the placement aid 3 can be separated from the pedestal 8. In particular, when the tooth veneer element 1 is held fixed, that is to say for example after the tooth veneer element has been successfully applied to a tooth, the placement aid 3 can be broken off at the predetermined breaking point. In the process, the pedestal 8 remains on the tooth veneer element 1. The pedestal 8 thus prevents a situation in which, during the separation process, any broken-out regions can extend into the body of the tooth veneer element 1. Since the pedestal 8 is removed in any case during the finish machining process, that is to say for example is ground and/or polished away, any broken-out regions on the pedestal 8 do not impair the quality of the end result.

FIGS. 6a to 6f show six main views of a further embodiment of a tooth veneer element 14 according to the invention for the veneering of a cervical region of a tooth, the tooth veneer element having the placement aid 3 and the predetermined breaking point 13. The pedestal 8 is arranged in a central region of the outer surface 2 of the tooth veneer element 14. The predetermined breaking point 13 is formed as a step between the pedestal 8 and the placement aid 3. In the plan views of FIGS. 6e and 6f, it can be seen that the axial length B in the direction of A is smaller than the width C in the direction perpendicular to A. In particular, the tooth veneer element 14 has a length B of 5.8 mm and a width C of 6.7 mm. Such a ratio of length B to width C falls into the category, used in the present case, of a collar-shaped form of a tooth veneer element according to the invention.

FIGS. 7a to 7f show six main views of a further embodiment of a tooth veneer element 15 according to the invention for the veneering of a cervical region of a tooth, the tooth veneer element having the placement aid 3 and the predetermined breaking point 13. In the plan views of FIGS. 7e and 7f, it can be seen that the axial length B in the direction of A lies in a similar range to the width C in the direction perpendicular to A. In particular, the tooth veneer element 15 has a length B of 5.6 mm and a width C of 5.1 mm. Such a ratio of length B to width C is, in the present case, likewise regarded as a collar-shaped form.

FIGS. 8a to 8f show six main views of a further embodiment of a tooth veneer element 16 according to the invention for the veneering of a cervical region of a tooth, the tooth veneer element having the placement aid 3 and the predetermined breaking point 13. The axial length B of the tooth veneer element 16 in the direction of A is considerably greater than the width C in the direction perpendicular to A. In particular, the tooth veneer element 16 has a length B of 10.1 mm and a width C of 7.5 mm. Such a ratio of length B to width C falls into the category, used in the present case, of an elongate form of a tooth veneer element according to the invention.

FIG. 9a to Of show six main views of a further embodiment of a tooth veneer element 17 according to the invention for the veneering of a cervical region of a tooth, the tooth veneer element having the placement aid 3 and the predetermined breaking point 13. The axial length B of the tooth veneer element 17 in the direction of A is considerably greater than the width C in the direction perpendicular to A. In particular, the tooth veneer element 17 has a length B of 9.4 mm and a width C of 6.6 mm. Such a ratio of length B to width C is in the present case likewise regarded as an elongate form.

As can be seen from the figures of the tooth veneer elements 14 to 17, these each have at least two regions which have different curvatures about the longitudinal direction A. In each of FIGS. 6f, 7f, 8f and 9f, hatching is used to indicate a region E which, when the respective tooth veneer element 14 to 17 is in the intended arrangement, is arranged at the root side. Since the tooth veneer elements 14 to 17 are designed to cover a facial tooth surface, they extend both partially over the tooth root and partially over the tooth crown when in the applied state. Said regions of the tooth generally have different curvatures perpendicular to the longitudinal direction of the tooth. The regions of different curvature of the tooth veneer elements 14 to 17 are therefore adapted in each case to the tooth to be veneered, or to the tooth regions on which the regions are arranged.

1. A tooth veneer element for a tooth, in particular for covering a facial neck surface of the tooth, wherein said tooth veneer element is designed to only partially cover a facial surface of a tooth crown of the tooth.

2. The tooth veneer element as claimed in claim 1, wherein said tooth is a human tooth.

3. The tooth veneer element as claimed in claim 1, wherein said tooth veneer element is designed such that the facial tooth neck surface of the tooth can be substantially completely covered.

4. The tooth veneer element as claimed in claim 1, wherein said tooth veneer element has a length of 5 to 12 mm.

5. The tooth veneer element as claimed in claim 1, wherein said tooth veneer element has a width of 4 to 8 mm.

6. The tooth veneer element as claimed in claim 1, wherein said tooth veneer element is manufactured from a composite material.

7. The tooth veneer element as claimed in claim 1, wherein said tooth veneer element comprises zinc oxide.

8. The tooth veneer element as claimed in claim 1, wherein said tooth veneer element has a translucency in the range from 12% to 45%.

9. The tooth never element as claimed in claim 8, wherein color values of the tooth veneer element in the Lab color space have the following values:
L value in the range from 55 to 88;
a value in the range from −4 to 4.5;
b value in the range from −2 to 24.

10. The tooth veneer element as claimed in claim 1, wherein said tooth veneer element is equipped with a placement aid by way of which the tooth veneer element can be directly or indirectly held by a user.

11. The tooth veneer element as claimed in claim 10, wherein the placement aid is integrally formed on, or is retroactively fastened to the tooth veneer element.

12. The tooth veneer element as claimed in claim 10, wherein the placement aid is arranged on an outer surface of the tooth veneer element and is in the form of a projection.

13. The tooth veneer element as claimed in claim 10, wherein a predetermined breaking point is provided for the separation of the placement aid from the tooth veneer element.

14. The tooth veneer element as claimed in claim 13, wherein the predetermined breaking point comprises a step, which encircles the placement aid, between the tooth veneer element and the placement aid.

15. The tooth veneer element as claimed in claim 10, wherein the placement aid has a coding, for identification of the tooth veneer element.

16. A kit having multiple tooth veneer elements for veneering tooth surfaces, wherein at least one of the tooth veneer elements (1) is designed as claimed in claim 1.

15. (canceled)

17. A method for applying a tooth veneer element as claimed in claim 1, in particular for non-curative, aesthetic tooth correction, wherein the tooth veneer element is applied to the tooth such that a facial surface of a tooth crown of the tooth is only partially covered.

18. The method as claimed in claim 17, wherein the tooth veneer element is applied to the tooth such that a facial tooth neck surface of the tooth is substantially completely covered.

19. The method as claimed in claim 17, wherein the tooth veneer element, after being applied to the tooth, is subjected to material removal such that a substantially smooth transition from the tooth veneer element to the facial surface of the tooth crown is formed.

20. A method for applying a tooth veneer element having a placement aid as claimed in claim 10, wherein during the application process, the tooth veneer element is at least temporarily held by a user directly or indirectly by way of the placement aid of the tooth veneer element.

21. The method as claimed in claim 20, wherein after the tooth veneer element has been applied, the placement aid is separated from the tooth veneer element.

22. The method as claimed in claim 20, wherein before the tooth veneer element is applied to the tooth, a suitable tooth veneer element is selected from a multiplicity of tooth veneer elements on the basis of a coding of the placement aid of the tooth veneer element.
